(19) United States
(12) Patent Application Publication
(10) Pub. No.: US 2017/0251700 A1
(43) Pub. Date: Sep. 7, 2017

(54) INSECT FEEDS

(71) Applicant: ADM Alliance Nutrition, Inc., Decatur, IL (US)

(72) Inventors: Perry Doane, Decatur, IN (US); Dale Hill, Quincy, IL (US)

(21) Appl. No.: 15/320,456

(22) PCT Filed: Jul. 2, 2015
(86) PCT No.: PCT/US15/38995

§ 371 Date: Dec. 20, 2016

Related U.S. Application Data
(60) Provisional application No. 62/020,581, filed on Jul. 3, 2014.

(51) Int. Cl. A23K 50/90; A23K 20/163; A23K 20/10; A23K 20/147; A23K 10/12; A23K 10/38

(52) U.S. Cl. CPC A23K 50/90; A23K 10/12; A23K 10/38; A23K 20/10; A23K 20/147; A23K 20/163

(57) ABSTRACT

Insect feeds comprising a derivative of corn steep liquid are disclosed. Methods of feeding such insect feeds to insects such as bees, are further disclosed. In each of its various embodiments, the present invention fulfills these needs and discloses improved feeds to be fed to bees and other insects. In one embodiment, the insect feed comprises a derivative of corn steep liquid. The derivative of the corn steep liquid may be selected from the group consisting of a product derived from fermentation using media comprising a corn steep liquid, solids derived from a com steeping process, gluten water, corn steep liquor, grain distillers dried yeast, a microbial biomass, and combinations of any thereof.

### TECHNICAL FIELD

The present invention relates generally to insect feeds and more particularly, to feeds used for bees.

### BACKGROUND OF THE INVENTION

Honey bees are an important pollinator of many major food crops, such as almonds, apples, and other tree crops, along with squash, melons, and many vegetable crops. The impact of honey bees on pollination is estimated to be greater than $15 billion for the United States economy. In addition to pollination, honey is used for human food and ingredient uses, not to mention the use of beeswax for candles and a variety of other applications.

Honey bees can normally forage for pollen and nectar from a wide variety of plants and depending on location, season, weather, and plant growth conditions, the pollen and nectar can vary greatly in nutrient content. The honey bees use this pollen to make a combination of pollen, nectar, salivary enzymes, and bacteria to make stores of fermented bee bread within the hive for feeding the larvae, workers, drones, and the queen bee.

The shipment of bees for crop pollination is common and in many instances, the pollen available for the bees as a food source may not be adequate in nutrient content to meet the nutritional needs of the bees. Less than optimal nutrition can result in less than optimal growth and survival of the bees. Honey bee nutrition continues to evolve as there is limited data available as compared to other commercial animal species. The honey bees ability to adapt and survive may be compromised due to possible nutrient deficiencies, declining habitat, transportation stresses on the bees when they are moved for crop pollination, possible dehydration, viruses, bacteria, parasites, and certain insecticides.

Feeding supplements used for bees includes sugar (dry and liquid forms), patties made from soy protein (usually soy flour or soy protein concentrate, either expeller-pressed or solvent extracted) mixed with brewers yeast; some patties may contain cotton seed oil, vitamin blends, skim milk, and/or egg protein. Although the development of feeding supplements for honey bees goes back nearly a century, needs exist for improved bee feeds to help address such nutrient deficiencies and support improving bee management.

### SUMMARY OF THE INVENTION

In each of its various embodiments, the present invention fulfills these needs and discloses improved feeds to be fed to bees and other insects.

In one embodiment, the insect feed comprises a derivative of corn steep liquid.

The derivative of the corn steep liquid may be selected from the group consisting of a product derived from fermentation using media comprising a corn steep liquid, solids derived from a corn steeping process, gluten water, corn steep liquor, grain distillers dried yeast, a microbial biomass, and combinations of any thereof.

The derivative of the corn steep liquid may also be a yeast biomass from an ethanol fermentation grown on a media comprising a corn steep liquid.

The insect feed may be a powder, a liquid, or a patty.

The insect feed may further comprise an ingredient selected from the group consisting of a carbohydrate source, a sugar, a protein source, a cholesterol source, a mannanoligosaccharide source, at least one ingredient, an anti-oxidant, a preservative, and combinations of any thereof.

The derivative of the corn steep liquid may also be minimally processed such that proteins and/or other components in the derivative of the corn steep liquid are minimally heat damaged.

At least 40% of protein in the insect feed may be derived from the derivative of the corn steep liquid. The derivative of the corn steep liquid may also be substantially free of corn gluten.

In a further embodiment, a method of feeding an insect comprises feeding the insect feed of the present invention to the insect. The insect may be a bee, a cricket, or other insect.

In yet an additional embodiment, a bee feed comprises 70-95% by weight of a yeast biomass obtained from fermenting the yeast on a corn steep liquid, wherein the yeast biomass comprises less than 1% by weight of corn gluten. The bee feed also comprises a carbohydrate source, a protein source, and a cholesterol source.

### DETAILED DESCRIPTION OF THE INVENTION

In one embodiment, the present invention is an insect feed. The feed may be a composition including ingredients and nutrients that targets the known nutrient needs for insects, such as honey bees, and may be fed in either dry, paste, or liquid form. The feed may also be fed to other insects including, but not limited to, crickets raised and used for commercial purposes, such as an animal food source.

In the present invention, honey bees have been used in various locations to compare the consumption of the insect feed of the present invention against other commercial formulas that claim to be nutritionally complete. It has been discovered that the insect feeds of the present invention are consumed in amounts equal to or greater than the commercially available formulas. In one embodiment, the insect feeds of the present invention were compared to the consumption and nutrient content of MEGABEE supplement, a commercially available bee feed.

Those of ordinary skill in the art understand that an optimal balance of amino acids, fatty acids, macro- and micro-minerals, vitamins, and carbohydrates from a variety of sources are needed to provide the optimal levels and balance of these nutrients to support optimal growth and health. Computerized formulation programs are often used to develop these types of formulas utilizing a variety of ingredients with complementary nutrient profiles.

The insect feed described herein has higher (calculated) levels of certain nutrients (specific amino acids) known to be essential to honey bees as compared to other commercial products.

In an embodiment, the insect feed comprises a derivative of a corn steep liquid. The derivative may be selected from the group consisting of a product derived from fermentation using media comprising a corn steep liquid, solids derived from a corn steeping process, gluten water, corn steep liquor, grain distillers dried yeast, a microbial biomass, and combinations of any thereof. As known by those of ordinary skill in the art, grain distillers dried yeast refers to the dried, non-fermentative yeast of the botanical classification Saccharomyces resulting from the fermentation of grain and yeast, separated from the mash, either before or after distillation which contains at least 40% crude protein. The derivative of the corn steep liquid may be substantially free of corn gluten, which refers to the fact that the compositions of the present invention have less than 1% corn gluten, less than 0.5% corn gluten, or even less than 0.1% corn gluten.

In a further embodiment, the derivative of the corn steep liquid is a yeast biomass grown on media comprising a corn steep liquid. The yeast biomass may be used to produce ethanol and may be minimally processed into a dry form, such as a powder. Such yeast biomass may be referred to herein as PROPLEX DY.

The derivative of the corn steep liquid of the present invention should not be confused with Brewers dried yeast, such as what is present in MEGABEE supplement. As known by those of ordinary skill in the art, Brewers dried yeast is the dried, non-fermentative, non-extracted yeast of the botanical classification Saccharomyces resulting as a by-product from the brewing of beer and ale which contains at least 35% crude protein, while the derivative of the corn steep liquor of the present invention originates from the wet milling of corn.

Some of the commercially available bee feeds include corn gluten which is produced from the wet mill processing of corn. In wet mill processing, initially, corn undergoes steeping, which incorporates some degree of fermentation. Corn is then ground and progressively separated. The corn gluten protein initially follows the wet starch slurry and is further separated based on density. After separation, wet corn gluten (wcg) is filtered to remove the residual liquid, gluten water (gH) which is reduced in nitrogen content and is substantially free of gluten proteins, is returned to the corn steep liquor stream. The wet corn gluten as a wet cake is dried (removing water and volatiles) to obtain commercial corn gluten meal (cgm). Palatability of CGM was compared to related sources of fermentation residuals arising from the corn steeping process and wet corn gluten which would have been exposed to less heat damage.

Upon completion of the steeping process, the steeped corn grain is separated for grinding from the liquid fraction or steep water. Other water or liquid sources from fiber, starch, or protein separations are often combined with the steep water. Water is removed from this overall liquid stream (usually by evaporation) to form corn steep liquor (CSL) as a feed ingredient containing a range of fermentation residuals as well as starch and/or other compounds lost through process inefficiencies. Depending on local markets, CSL may be further combined with corn fiber or other factions to form corn gluten feed in either dry or wet form.

In a further embodiment, the insect feed of the present invention includes a liquid derived from a corn steeping process. The liquid may have 1-60% solids by weight. In a further embodiment, such liquid may be dried to form a dry product, such as a powder, derived from the corn steeping process.

Yeast has a good amino acid profile for insect formulations and is well accepted by customers for use in in honey bee supplements. Corn steep water or corn steep liquor can be used as nutrient sources for commercial fermentations, for example to produce ethanol or amino acids. Depending on conditions, residual components from corn steeping may remain and additional fermentation residuals be contributed. When the microbial mass is separated from the parent fermentation, some of the material responsible for improved palatability by insects may be retained and captured. In addition, a variety of yeast sources are available with variable methods of drying and concomitant heat exposure.

In an additional embodiment, the insect feed of the present invention includes a fermentation biomass grown on a media comprising a liquid derived from a corn steeping process. In one embodiment, the fermentation biomass is substantially free of corn gluten. Such fermentation biomass may be dried using minimal heat or for a minimal amount of time. The fermentation biomass may be selected from the group consisting of yeast, distiller's yeast, brewer's yeast, biomass from a commercial amino acid biomass, citric acid presscake, glutamate biomass, threonine biomass, lysine biomass, a microbial biomass, or other biomass grown on a media derived from a corn steeping process.

In other embodiments, the insect feed may comprises other ingredients including, but not limited to, sugar, a protein source, a cholesterol source, a mannanoligosaccharide source, at least one ingredient, an anti-oxidant, a preservative, and combinations of any thereof.

Sugars that may be used include, but are not limited to, high fructose corn syrup, sucrose, dextrose, glucose, fructose, maltose, trehelose, and combinations of any thereof.

Protein sources that may be used include, but are not limited to, soy proteins, wheat proteins, pea proteins, potato protein, or combinations of any thereof. Protein isolates and/or protein concentrates may be used. Example of proteins include without limitation soy protein isolate, soy protein concentrate, wheat protein isolate, wheat gluten, pea protein, rice protein, and combinations of any thereof. CLARISOY brand soy protein isolate and PROFAM brand soy protein isolate were found to be accepted by bees in the studies described herein.

In one embodiment, the total protein of the insect feed is between 15% and 85%, and in another embodiment, between 35% and 65%, or between 40% and 60%. In patty form, the insect feed of the present invention comprises about 18-24% protein. The protein may be derived from dried Saccharomyces cerevisiae yeast (i.e., dried grain distillers yeast or other yeasts such as dried Pichia guilliermondii yeast), soy protein (i.e., soy protein isolate, soy protein concentrate, or soy flour), pea protein concentrate, pea protein isolate, wheat gluten, wheat protein isolate, flax, sunflower meal, safflower meal, wheat germ meal, corn germ meal, dried whole egg, skim milk, dried whey, whey protein concentrate, whey protein isolate, the protein from grain flours (grain sorghum, wheat flour, rice flour, wheat starch, oat flour, corn flour, corn starch, products from root crops such as potato flour, potato starch, and/or tapioca starch, or combinations of any thereof), specific amino acids (lysine and/or methionine and/or isoleucine), or combinations of any thereof. A variety of protein sources may be used to achieve the protein content and desired amino acid levels and balances.

In a further embodiment, a cholesterol source that may be used is dried egg powder. The egg powder may also be a source of lipid, fatty acid, and/or other sterols.

In a further embodiment, the insect feed has a lipid content of between about 2-10% or between 3-7%. The lipids may originate from dried whole egg, lecithin, grains, yeast sources, or combinations of any thereof.

The dried egg product may be added as a lipid and fatty acid source, and as a source of cholesterol and other sterols. Some of the compounds found in egg are classed as lipoproteins—providing both protein in the form of amino acids and lipids in the form of fatty acids. In the insect feed, the lipids may be protected with a mixed tocopherol-based antioxidant which supplies alpha, beta, delta, and gamma tocopherol isomers. In other embodiments, polyphenolics from cinnamon and/or other spices may also be added for flavor and/or antioxidant properties. In other embodiments, essential oils, such as lemon grass oil or extract from citrus peel, may also be used in the insect feed. Specific fatty acids (C-2 to C-24) may also be added to the insect feed such as the short chain volatile fatty acids.

In another embodiment, a mannanoligosaccharide source that may be used is a CITRISTIM fermentation biomass, which is a fermentation biomass product from a citric acid fermentation product.

In an additional embodiment, the at least one ingredient may include micronutrients such as choline chloride, lysine hydrochloride, potassium chloride, methionine, and combinations of any thereof. In other embodiments, the at least one ingredient may be vitamins and minerals added to the insect feed to meet or exceed known and published nutrient levels for the specific insect, such as honey bees. Potassium chloride may be the primary macro-mineral added and any combination of the traditional trace minerals may also be added, either in the inorganic or organic forms. Vitamins, fat-soluble and water-soluble, may also be added. In an embodiment, the source of vitamin E may be in the d-alpha-tocopheryl acetate form derived from vegetable oils. Choline chloride may also be added to the insect feed.

In a further embodiment, an anti-oxidant may be used to protect the lipids in the insect feed. The anti-oxidant may be a mixed tocopherol-based antioxidant or may be a phenolic product such as cinnamon or a quinone.

In a further embodiment, the insect feed may have a total carbohydrate content of between 10-90%, between 20-60%, between 1-50%, or between 2-20% which may come from various grain based ingredients. In one embodiment, the carbohydrate source may be a flour. Various testing of combinations of brewers yeast with different flours has revealed that bees appeared to prefer wheat flour, sorghum flour, and rice flour over corn flour, oat flour, or barley flour. However, any flour may be used in the insect feeds of the present invention.

In one embodiment, the preservative may be an organic acid. Non-limiting examples of preservatives that may be used are lactic acid, citric acid, or combinations thereof. The organic acids may be included in the insect feed at 0.1% to 5% for pH control, to discourage bacterial growth, and as an intestinal tract acidifier in the insect consuming this product. Such preservatives may include, but are not limited to, citrate, isocitrate, α-ketogluterate, succinate, fumarate, malate, oxaloacetate, acetic acid, pyruvic acid, lactic acid and/or propionic acid, other known preservatives, singly or in any combination. These acids may be added either into the dry formula of a dry insect feed, or into a liquid fraction when making patty products. Such acids may be added to keep the pH below 6.0 to minimize bacterial growth and promote intestinal health of the insect.

A total ash content of the insect feeds of the present invention may be between 2-10%, 2-8%, or 2-5%. Various minerals and/or vitamins may be added to the insect feed to meet or exceed known nutrient levels of the target insect or honey bees.

In a further embodiment, an insect feed of the present invention includes about 50-55% sugar and about 45-50% protein portion. The protein portion may include about 48-50% PROPLEX DY yeast product, about 24% soy protein isolate, about 16% sorghum flour, about 3% dried egg powder, about 3% dry lecithin, about 2.7% CITRISTIM brand mannanoligosaccharides, about 0.27% methionine, about 0.5% potassium chloride, about 1.1% choline chloride, about 0.3% lysine hydro-chloride, and about 0.05% cinnamon.

In other embodiments, emulsifiers, such as lecithin, and/or humectants, such as glycerin, betaine, or propylene glycol may be included in the insect feed.

In other embodiment, the particles of the insect feed may have a size of less than 150 microns, less than about 100 microns, and in another embodiment, the particles may have a size of less than 75 microns. In some working examples of the insect feed, larger particles appeared to soften and break down in a patty matrix and were readily consumed without being wasted as compared to other commercially available insect feeds having a smaller particle size.

In one embodiment, the insect feed of the present invention may be fed to honey bees or other insects as a dry powder, blended with sugar and fed as a dry powder, or fed as a patty including the dry powder blended with a liquid (comprising 20-80% of the liquid) such as high fructose corn syrup, glucose, sugar (sucrose and/or dextrose), corn steep liquor, corn steep water, glycerin, or combinations of any thereof to make a dough of a desired consistency for feeding. In an embodiment, a protein content of the patty is within the range of 15% to 25%. When fed in the dry form, the insect feed of the present invention may also be blended with sugar in the form of sucrose and/or dextrose.

When a dry powder of the insect feed of the present invention is combined with a liquid, an easily mixed product that is a smooth texture, with even mixing easily achieved with minimal clumping is achieved. In one embodiment, the insect feed includes 30% to 60% dry powder and 30% to 60% of a liquid fraction. In another embodiment, 0% to 40% dry sugar may be added to adjust the patty consistency and texture as desired. Such insect feed may also be rolled between two sheets of waxed paper to approximately ¼ inch thickness for ease of handling and ease of feeding. The insect feed may also be fed in other containers that will allow bees or other insects access to the patty. Such insect feed may also be refrigerated or frozen until ready to place in the insect's hive or other environment. Frozen material should be thawed before placing in the hive or other environment for feeding.

In a further embodiment, the insect feed of the present invention may be used as a dry protein supplement powder and/or the patty (combination of the dry powder and the liquid fractions) and fed inside the hive in close proximity to the bee brood areas or is fed adjacent to, but outside of the hive.

It has been unexpectedly discovered that the insect feeds of the present invention were readily consumed and often preferred by honey bees as compared to other commercially available insect feeds. This is of note since insect feeds that are not readily consumed by the insects do not provide the nutrients required by insect.

The working examples herein demonstrate that the insect feeds of the present invention were preferred by honey bees as compared to other commercially available insect feeds. Without meaning to be limited by theory, it is thought that the presence of the various fermented products in the insect feeds of the present invention are what make the insects feeds of the present invention more desirable by the honey bees. As bees collect pollens and nectars from plants in nature, such pollens and nectars are combined with digestive enzymes and stomach contents of the worker bees. The worker bees pack this blend into wax cells and seal the wax cells where such blend ferments and becomes “bee bread.” Such bee bread is used as one of the primary food sources during egg laying and brood expansion in late winter, spring, and summer. One of the surprising discoveries of the present invention is that bees prefer feeds with a fermented flavor, which is achieved by using the various fermented products of the present invention.

The various fermented products of the present invention are typically “minimally” processed and, thus, retain a “fermented characteristic” similar to that of bee bread. Minimally processed means that the product is not subjected to various processes including being subjected to high heat (i.e., temperatures less than 200° C., 190° C., 180° C., 170° C., 160° C., 150° C., 140° C., 130° C., 120° C., 110° C., or 100° C.), centrifugation, drying, or other processing condition. For instance, the fermented products of the present invention are dried at lower temperatures or for short amounts of time and are thought to retain the fermented characteristic as compared to other fermented products, such as yeast products, which are dried and/or processed at harsher temperatures or other conditions. The “minimal” processing means that the amount of heat damage done to proteins in the fermented products is minimized.

### EXAMPLES

The present invention is further demonstrated by the examples that follow:

### Example 1

A group of 6 hives was set up at a test site. Hives were newly constructed and 3-lb honey bee packages were introduced. Over the duration of the honey bee season with swarming and separation of queen cells into “splits,” the number of hives expanded to 9.

To evaluate the preference or palatability of various ingredients, sugar solutions containing small amounts of each ingredient were placed into the hives and the consumption of each ingredient was measured. For each hive used in the test, three jars were placed inside an empty hive body (9 ⅝ inch height) used as a spacer between the inner and outer covers of the hive. Each jar was marked with 100 ml graduations, fitted with the appropriate caps and front feeders to allow bees access to the sugar solution when inverted. The various ingredients to be analyzed were dissolved or suspended in a 50% HFCS (high fructose corn syrup) sugar solution.

The various ingredients to be evaluated were dissolved or suspended in distilled water to form a 10% ‘solution’ and 50 ml of this suspension was added to 55% HFCS, and further diluted to reach a final volume of 1500 ml per jar or about a 0.3% mixture of test ingredient as presented to the hive in a 50% HFCS solution. Within each hive, one of the test jars contained only sugar solution with the remaining 2-jars containing test ingredients. Sugar consumption and, thus, length of observation period varied throughout the study population and activity of the hives reflected weather patterns and growth status of the hives. For the purpose of this study, “period” incorporates both season and length of observation time to measure sugar consumption.

The ingredients to be evaluated were separated into study groups (3-5 ingredients each). For each ingredient grouping, ingredients were structured into pairs to form partial factorial or incomplete block designs. Pairs of ingredients from a specific grouping of ingredients were placed in hives (with sugar as control) and observational periods proceeded until observations were obtained for each ingredient from a minimum of six (6) separate hives and each pairing was observed in a minimum of two (2) separate hives. On occasion, evaluation of different study groups would overlap within a single test ‘period’ as affected by individual hive management to increase observation numbers, and to aid statistical comparison among treatment ingredient groupings.

Sugar consumption varied widely across seasonal and weather patterns. Fall consumption (post-honey harvest) may have compressed differences in preference. Ingredients evaluated in the fall periods are presented within the overall comparisons (Table 1), but those observations are not presented in detail. Observation period combines several potential confounding influences for interpretation of results. Since ingredients entered the study as groups, some ingredients are considered in multiple comparisons, while others were evaluated only in a short span of observation periods. The biology of the hive shifts considerably with expansion, maturation, and consolidation across seasonal changes. Weather affects activity level with wet or cool periods shifting the number of active external hours, which in turn interacts with the amount and type of plants in flower producing a variable quantity and quality of nectar or pollen across a shifting geography of plant access. Individual groupings of ingredients will also be discussed to minimize some period effects.

A simple sugar solution was available in all cases to provide a basis of comparison. Where global comparisons are of interest, comparison of ingredient consumption to sugar intake provides the most stable evaluation. The daily percent of total sugar consumption within a period related to each ingredient is also presented. Generally, conclusions based on preference follow the same pattern as consumption values, but tend to accentuate differences.

Thirty-eight (38) observation periods were used to evaluate 25 ingredients and combinations. Table 1 presents sugar consumption and preference (daily percent of total period consumption) for all ingredients evaluated. For some periods, consumption of sugar solutions containing added ingredients exceeded that of the 50% HFCS sugar. Lactic acid, although not significantly less than sugar, appeared to be mildly inhibitory. Apparent in the overall ranking was the observation that ingredients and combinations which contained residuals within the liquid fraction from the corn steeping process were substantially preferred by the bees. Corn gluten meal (which is commercially used as a bee feed) was well accepted, but not substantially different than other proteins offered, such as wheat gluten, and CLARISOY and PROFAM brand isolated soy proteins, available from Archer-Daniels-Midland Company, Decatur, Ill.

Groups of ingredients are presented below, limiting period effects, and providing more conservative comparisons. It was observed that intake was more variable later in the season and ingredients from the later period are not discussed in detail.

TABLE 1
Consumption of sugar solutions including various ingredients.

| | | Consumption | | Pct Intake | |
|---|---|---|---|---|---|
| Ingredient | Abbrev. | ml/d | StdDev | % ing/d | StdDev |
| Lactic Acid | Lac | 85^{a} | 17 | 7.4^{ab} | 1.3 |
| Sugar | sugar | 86^{a} | 4 | 6.5^{a} | 0.3 |
| Sorghum flour | sgf | 88^{a} | 19 | 6.7^{ab} | 1.4 |
| Corn gluten meal | cgm | 90^{a} | 19 | 6.6^{ab} | 1.4 |
| Wheat gluten | Wg | 90^{a} | 19 | 7.6^{ab} | 1.4 |
| CLARISOY | CL | 91^{a} | 17 | 6.2^{ab} | 1.2 |
| Wheat gluten + gH | gWg | 92^{a} | 16 | 8.3^{ab} | 1.2 |
| Nutricell yeast | ncy | 93^{a} | 18 | 5.2^{a} | 1.4 |
| glycerol | gly | 94^{ab} | 21 | 7.3^{ab} | 1.5 |
| Wheat gluten + | cWg | 96^{ab} | 16 | 8.4^{ab} | 1.2 |
| cCSL | | | | | |
| Lysine biomass | lysB | 97^{ab} | 18 | 5.9^{ab} | 1.4 |
| PROFAM + rsy | rpf | 98^{ab} | 25 | 5.5^{ab} | 1.8 |
| Tofu | ingrtf | 99^{ab} | 33 | 7.9^{abc} | 2.4 |
| ADM yeast | gdy | 108^{ab} | 18 | 7.1^{ab} | 1.4 |
| PROFAM | pf | 110^{ab} | 15 | 8.2^{ab} | 1.1 |
| Red Star yeast | rsy | 112^{ab} | 22 | 6.9^{ab} | 1.6 |
| Propionic acid | Pr | 115^{ab} | 22 | 9.1^{abc} | 1.7 |
| Acetic acid | Ac | 116^{ab} | 22 | 9.6^{bcd} | 1.7 |
| Wet corn gluten | wcg | 138^{b} | 19 | 9.5^{bc} | 1.3 |
| PROFAM + cCSL | cpf | 167^{bc} | 18 | 12.1^{cde} | 1.4 |
| Gluten water (gH) | gH | 171^{bc} | 12 | 13.0^{de} | 0.9 |
| Cedar—Steep | cCSL | 182^{c} | 12 | 13.9^{e} | 0.9 |
| Liquor | | | | | |
| dried—Steep | dCSL | 190^{c} | 16 | 13.1^{de} | 1.2 |
| Liquor | | | | | |
| Decatur Steep | aCSL | 202^{c} | 16 | 14.8^{e} | 1.2 |
| Liquor | | | | | |
| CLARISOY + gW | gCS | 274^{d} | 19 | 19.3^{f} | 1.4 |
| (gluten water) | | | | | |

^{abc}Means within columns with different superscripts are different P < .10

Table 2 indicates that corn gluten meal is readily accepted by bees when suspended in a sugar solution. Unexpectedly, consumption is greatly improved for either wet corn gluten or the residual gluten water in relation to the corn gluten meal. Corn gluten meal has been promoted as a readily available, relatively concentrated and highly palatable protein source for honey bees. These results suggest that either by separation of liquids or heat exposure during commercial drying to produce corn gluten meal, the quality of the corn gluten meal measured by acceptance by honey bees has been reduced.

TABLE 2
Corn gluten meal (CGM) as a source of corn steep residuals.

| | Consumption, | Ingredient |
|---|---|---|
| | ml/d | Preference, %/d |
| Sugar | 92^{a} | 6.7^{a} |
| Corn Gluten Meal | 99^{a} | 7.0^{ab} |
| Wet Corn gluten | 148^{b} | 10.4^{b} |
| Gluten “water” | 177^{b} | 13.0^{b} |

^{ab}Means within columns with different superscripts differ P < .05

The effect of corn protein content on consumption of sugar suspensions containing corn steeping residuals was evaluated using ingredients obtained from commercial corn processing. Commercial corn steep liquor was obtained. Wet corn gluten was obtained. Gluten water was obtained by centrifugation of the wet gluten slurry at 10,000 g and decanting of the upper liquid. The CSL and wet gluten were diluted to form a 10% suspension. The ingredient suspensions and gluten water were included in 50% HFCS solutions at 50 ml per 1500 ml of final solution.

As presented in Table 3, each of the ingredients tested were consumed more rapidly and in greater quantity than the control sugar solution. Inclusion of corn protein did not appear to be required to increase sugar consumption where both CSL and gluten water (corn gluten protein almost entirely absent) were consumed more readily than the wet gluten slurry.

TABLE 3
Sources of fermentation residuals from corn steeping.

| | Consumption, | Ingredient |
|---|---|---|
| | ml/d | Preference, %/d |
| Sugar | 94^{a} | 6.7^{a} |
| Wet corn gluten | 162^{b} | 11.2^{b} |
| Corn Steep Liquor | 180^{b} | 13.5^{b} |
| Gluten water | 188^{b} | 13.8^{b} |

^{ab}Means within columns with different superscripts differ P < .05

Three sources of corn steep liquor were obtained to evaluate the potential ingredient variability and possible differences in quality. Corn steep liquor was obtained as an example of typical CSL. Material was obtained from a process (aCSL) which contained solubles from other commercial corn fermentations in addition to steeping water, and a dried CSL commercially available (Roquette, dCSL) was obtained.

As demonstrated with earlier observations, all sources of corn steep residuals were substantially preferred by the bees to the control sugar solution as shown in Table 4. Differences among the sources were small, although there was a slight numerical decrease in the relative preference (% of ingredient consumed per day) for the dried CSL which could suggest the potential from heat damage of drying the CSL.

TABLE 4
Comparison of corn steep liquor sources.

| | Consumption, | Ingredient |
|---|---|---|
| | ml/d | Preference, %/d |
| Sugar | 80^{a} | 5.5^{a} |
| aCSL | 168^{b} | 13.3^{a} |
| cCSL | 173^{b} | 12.8^{a} |
| dCSL | 177^{b} | 12.7^{a} |

^{ab}Means within columns with different superscripts differ P < .05

Corn gluten meal (CGM) has been used as a palatable source of protein for honey bees, but CGM is also deficient in lysine content relative to requirements which creates additional constraints for nutrient formulation of supplements to honey bees or other insects. Other proteins may provide greater flexibility in nutrient formulation and physical form of supplementation (particle size, improved suspension or solubility in sugar solution, in resiliency of a formed supplement). Relative palatability of protein suspensions for corn gluten meal, wheat gluten, and two soy proteins (CLARISOY and PROFAM 981 brand soy protein isolates) were evaluated.

There were no significant differences for preference in sugar solutions among ingredients of Table 5. CGM was not preferred over other protein sources. The alternative proteins in this experiment were high in protein content and manufactured as food grade which may have received less heat exposure than feed grade material. Based on these results, several sources of proteins would appear to be acceptable for further evaluation and use in insect feed supplements.

TABLE 5
Comparison of protein ingredients used in sugar suspensions.

| | | Ingredient |
|---|---|---|
| | Consumption, ml/d | Preference, %/d |
| Sugar | 67 | 5.0 |
| Wheat Gluten | 71 | 5.6 |
| CGM | 74 | 5.3 |
| CLARISOY soy | 74 | 5.2 |
| protein isolate | | |
| PROFAM 981 soy | 82 | 6.0 |
| protein isolate | | |

^{ab} Means within columns with different superscripts differ P < .05

A commercially available Brewers yeast (NutriCell) was compared to two yeasts, a yeast biomass used in producing ethanol (distillers yeast) and a lysine biomass, each recovered from fermentations utilizing corn steep liquor as a media and dried. Heat exposure was typically minimized during formation of the dry yeast products from the corn steep liquor to support intestinal protein digestibility as insect feed.

As shown in Table 6, consumption of sugar solutions containing Brewer's yeast was very good, but not different than the control sugar. Numerically daily intake and preference was greater for the lysine biomass and the distillers yeast where the distillers yeast was significantly improved relative to sugar controls. These results support the use of biomass sources grown with corn steep fermentation residuals as protein sources for honey bee or insect supplements.

TABLE 6
Evaluation of fermentation biomass sources.

| | | Ingredient |
|---|---|---|
| | Consumption, ml/d | Preference, %/d |
| Sugar | 92^{a} | 7.4^{a} |
| Brewer's yeast | 102^{ab} | 7.4^{ab} |
| Lysine Biomass | 110^{ab} | 8.2^{ab} |
| ADM yeast | 114^{b} | 8.9^{b} |

^{ab}Means within columns with different superscripts differ P < .05

Corn steep liquor and gluten water were added in combination with wheat gluten to evaluate the potential to improve consumption or preference of protein suspensions. Wheat gluten was suspended in distilled water, in gluten water, or a combination of corn steep liquor and wheat gluten were diluted into water at 5% solids, and 50 ml of ingredient solutions were incorporated into a final volume of 1500 ml HFCS solution. Pairs of ingredients, in standard front feeders, were placed into an empty hive body on top of each hive with a control sugar solution. Ingredients entered a group of six hives in a partial factorial arrangement. Across feeding periods, consumption from a minimum of 6 hives was obtained for each ingredient, where each pair of ingredients was present in at least 2 hives.

As shown in Table 7, consumption of wheat gluten in a sugar solution was not different from the control. Using corn steep liquor or gluten water improved consumption of the protein suspension. Individually, relative preference (% of total offered consumed per day) of the wheat gluten and CSL or wheat gluten and gluten water suspensions were not different from the control. However, as a group, the inclusion of steep residual from both sources did significantly increase the proportion of total solutions offered than was associated with the wheat gluten combinations.

TABLE 7
Use of corn steep residuals to improve
consumption of wheat gluten.

| | | Ingredient |
|---|---|---|
| | Consumption, ml/d | Preference, %/d |
| Sugar | 102^{a} | 7.3^{a} |
| Wheat Gluten | 105^{a} | 7.7^{a} |
| Wheat Gluten and gluten water | 132^{b} | 9.6^{a} |
| Wheat Gluten and CSL | 132^{b} | 9.5^{a} |
| CSL | 184^{c} | 13.7^{b} |
| Gluten water | 186^{c} | 13.9^{b} |

^{ab}Means within columns with different superscripts differ P < .05.

Soy products have occasionally caused concern within protein substitutes for honey due to concern over the content of poorly utilized and potentially toxic sugars. However, soy protein is a good source of lysine and protein isolates have very low sugar content. In a pair of small studies, corn steep liquor and gluten water were added in combination with two soy proteins to evaluate the potential to improve preference of protein suspensions. PROFAM brand soy isolate and CLARISOY brand soluble soy isolate were suspended in distilled water, in gluten water, or as a combination of corn steep liquor and protein were diluted into water to obtain 10% solids. For feeding, 50 ml of ingredient solutions were incorporated into a final volume of 1500 ml 50% HFCS solution. Pairs of ingredients, in standard front feeders, were placed into an empty hive body on top of each hive with a control sugar solution. Ingredients entered a group of six hives in a partial factorial arrangement. Across feeding periods, consumption from a minimum of 6 hives was obtained for each ingredient, where each pair of ingredients was present in at least 2 hives.

As shown in Table 8, consumption of soy proteins in sugar solution was similar to the control. Using corn steep liquor or gluten water improved consumption of the soy protein suspension. Relative preference for PROFAM brand soy isolate alone was not significantly different from the control, however the combination with CSL was improved relative to sugar alone although not statistically separated from PROFAM brand soy isolate itself. When both proteins were paired, combinations of soy protein and corn steep residuals were clearly improved in terms of preference and resulting consumption. In particular. the combination of CLARISOY brand soy isolate and gluten water were consumed to substantially greater extent than any other material offered.

TABLE 8
Use of corn steep residuals to improve
consumption of wheat gluten.

| | | Ingredient |
|---|---|---|
| | Consumption, ml/d | Preference, %/d |
| Sugar | 89^{a} | 6.3^{a} |
| CLARISOY soy | 91^{a} | 6.2^{a} |
| protein isolate | | |
| PROFAM 981 soy | 114^{a} | 7.8^{ab} |
| protein isolate | | |
| PROFAM 981 soy | 162^{ab} | 11.3^{bc} |
| protein isolate and CSL | | |
| Gluten water | 180^{b} | 13.4^{c} |
| CSL | 181^{b} | 13.2^{c} |
| Clarisoy and gluten water | 274^{c} | 19.1^{d} |

^{ab}Means within columns with different superscripts differ P < .05

From this Example, it can be concluded that the palatability of proteins by honey bees can be improved by the use of fermentation end-products, such as those produced or derived from liquids originating from a corn steeping process. It also appears that heating of products may reduce the palatability of feeds for honey bees.

### Example 2

### Patty Feeding

Formulas were compared against MEGABEE brand protein supplement. Protein patty formulas were essentially formula containing about 18-22% with varying protein sources, a carbohydrate source (usually wheat flour, sorghum flour and/or rice flour), sucrose, water, and high fructose corn syrup added to form a patty that was close to peanut butter consistency. The various protein supplement formulas were weighed into plastic jar lids (holding about 50 grams of supplement each), placed into the hives on top of the frames. A 2″ spacer was added to hives to allow room for these jar lid feeders between the frames and the inner cover of the hives. The jar lids with the MEGABEE supplement and test formulas were weighed initially and at 2 day intervals through day 6. There were always 3 test formulas compared against MEGABEE supplement, with each hive as the experimental unit, with this being replicated in at least 4 hives. Consumption/disappearance of the bee feed was determined by weight, with consumption of each bee supplement in the hive normalized across hives as % of each supplement consumed in each hive. This percentage was used for comparison. This was done to adjust for the strength/number of bees in each hive.

Management of bee hives typically includes syrup feeding (refined table sugar (sucrose) and water mixed 1:1) or dilution of high fructose corn syrup (HFCS) with a fructose concentration of 55%, either in a 1:1 ratio or a 2:1 ratio of HFCS to water. This practice encourages the bees to build comb for brood and honey storage. In combination with these syrups, various additives were tested and corn steep liquor products were noted to enhance syrup consumption per the previous Example.

Protein supplement evaluation. A series of 11 test periods were conducted. Six hives were used in the early studies and through swarming and bee losses, 4 hives were still in use in the latter tests.

The MEGABEE supplement formula that was used as the control is based on brewers yeast, soy protein concentrate, distillers grains with solubles, corn gluten meal, barley flour, and citric acid.

Study 1. The following formulations were used to feed hives and the average consumption was measured for 6 hives. The formulations and average consumption are presented in Table 10.

TABLE 10
All values are in grams. The amount of water varied
and was added to get a paste consistency.

| | Formulation | Formulation | Formulation | Formulation |
|---|---|---|---|---|
| Ingredient | 1 | 2 | 3 | 4 |
| Sorghum flour | 125 | 0 | 0 | 0 |
| Corn steep | 0 | 125 | 0 | 0 |
| liquor | | | | |
| Pea protein | 0 | 0 | 125 | 0 |
| MEGABEE | 0 | 0 | 0 | 125 |
| supplement | | | | |
| Sugar | 25 | 25 | 25 | 25 |
| Water | 125 | 50 | 300 | 100 |
| Average | 11.5 +/− | 1.9 +/− | 19.4 +/− | 8.6 +/− |
| Consumption | 2.3 | 1.2 | 1.4 | 1.8 |
| after 3 days | | | | |

Study 1 indicated that bees appeared to prefer pea protein powder and sorghum flour over MEGABEE supplement or corn steep liquor, however, the corn steep liquor patty became dry and hard and the bees may not have been able to consume it very well.

Study 2. The following formulations were used to feed hives and the average consumption was measured for 6 hives. The formulations and average consumption are presented in Table 11.

TABLE 11
All values are in grams. The amount of water varied
and was added to get a paste consistency.

| | Formulation | Formulation | Formulation | Formulation |
|---|---|---|---|---|
| Ingredient | 1 | 2 | 3 | 4 |
| Brewers yeast | 80 | 65 | 57 | 0 |
| Sucrose | 37.5 | 37.5 | 37.5 | 0 |
| Water | 17 | 20 | 19 | 75 |
| Sorghum flour | 12 | 0 | 15 | 0 |
| Lactic acid | 1.5 | 1.5 | 1.5 | 0 |
| PROFAM soy | 0 | 21 | 18 | 0 |
| protein isolate | | | | |
| MEGABEE | 0 | 0 | 0 | 150 |
| supplement | | | | |
| Average | 6.3 +/− | 4.5 +/− | 8.3 +/− | 12.2 +/− |
| Consumption | 0.8 | 0.5 | 0.5 | 2.3 |
| after 3 days | | | | 7.6 +/− |
| | | | | 1.5 |
| | | | | (corrected |
| | | | | for mois- |
| | | | | ture loss) |

The lactic acid reacted with the soy protein and formed a “plasticized” chunk that was not consumed well by the bees. Lactic acid would work well as a preservative.

Study 3. The following formulations were used to feed hives and the average consumption was measured for 6 hives. The formulations and average consumption are presented in Table 12.

TABLE 12
All values are in grams. These were offered as dry ingredients.

| | Formulation | Formulation | Formulation | Formulation |
|---|---|---|---|---|
| Ingredient | 1 | 2 | 3 | 4 |
| MEGABEE | 75 | 0 | 0 | 0 |
| supplement | | | | |
| Potato protein | 0 | 75 | 0 | 0 |
| Wheat gluten | 0 | 0 | 75 | 0 |
| Glycine | 0 | 0 | 0 | 75 |
| Sugar | 25 | 25 | 25 | 25 |
| Average | 0.3 +/− | 1.5 +/− | 1.3 +/− | 0.7 +/− |
| Consumption | 2.3 | 1.2 | 1.4 | 1.8 |
| after 3 days | | | | |

There was a low consumption of dry ingredients indicating bees prefer the higher moisture products.

Study 4. The following formulations were used to feed hives and the average consumption was measured for 6 hives. The formulations and average consumption are presented in Table 13.

TABLE 13
All values are in grams. The amount of water varied
and was added to get a paste consistency. The patties
were formulated to include about 22% crude protein.

| | Formulation | Formulation | Formulation | Formulation |
|---|---|---|---|---|
| Ingredient | 1 | 2 | 3 | 5 |
| Brewers yeast | 75 | 50 | 50 | 0 |
| Potato protein | 9 | 0 | 6 | 0 |
| Wheat gluten | 0 | 0 | 25 | 0 |
| Sorghum flour | 28 | 0 | 0 | 0 |
| Rice flour | 0 | 33 | 0 | 0 |
| Wheat flour | 0 | 0 | 25 | 0 |
| Egg powder | 2.5 | 2.5 | 2.5 | 0 |
| Lecithin | 1 | 1 | 1 | 0 |
| High fructose | 200 | 200 | 200 | 200 |
| corn syrup | | | | |
| Lactic acid | 2.5 | 2.5 | 2.5 | 0 |
| Pea protein | 0 | 36 | 17 | 0 |
| PROFAM soy | 32 | 25 | 21 | 0 |
| protein isolate | | | | |
| MEGABEE | 0 | 0 | 0 | 150 |
| supplement | | | | |
| Average | 3.5 +/− | 3.5 +/− | 2.2 +/− | 10.8 +/− |
| Consumption | 4.1 | 5.6 | 3.0 | 15.8 |
| after 6 days | | | | |

There was good pollen availability during this study and a low consumption of the pollen substitute.

Study 5. The following formulations were used to feed hives and the average consumption was measured for 5 hives. The formulations and average consumption are presented in Table 14.

TABLE 14
All values are in grams. The amount of water varied
and was added to get a paste consistency.

| | Formulation | Formulation | Formulation | Formulation |
|---|---|---|---|---|
| Ingredient | 1 | 2 | 3 | 5 |
| Brewers yeast | 75 | 0 | 72 | 0 |
| PROPLEX DY | 0 | 75 | 0 | 0 |
| CLARISOY | 56 | 56 | 53 | 0 |
| soy protein | | | | |
| isolate | | | | |
| High fructose | 210 | 210 | 210 | 210 |
| corn syrup | | | | |
| Lactic acid | 3 | 3 | 3 | 0 |
| Lecithin | 1 | 1 | 1 | 0 |
| Methionine | 1 | 1 | 1 | 0 |
| Egg powder | 3 | 3 | 3 | 0 |
| MEGABEE | 0 | 0 | 0 | 140 |
| supplement | | | | |
| Average | 2.5 +/− | 6.3 +/− | 3.8 +/− | 9.0 +/− |
| Consumption | 2.6 | 1.5 | 3.8 | 4.6 |
| after 6 days | | | | |

There was good pollen availability during this study and a low consumption of pollen substitute.

Study 6. The following formulations were used to feed hives and the average consumption was measured for 4 hives. The formulations and average consumption are presented in Table 15.

TABLE 15
All values are in grams. These were offered as dry ingredients.

| | Formulation | Formulation | Formulation | Formulation |
|---|---|---|---|---|
| Ingredient | 1 | 2 | 3 | 4 |
| Brewers yeast | 126 | 0 | 72 | 0 |
| PROPLEX DY | 0 | 120 | 0 | 0 |
| CLARISOY | 46 | 56 | 51 | 0 |
| soy protein | | | | |
| isolate | | | | |
| High fructose | 240 | 240 | 240 | 240 |
| corn syrup | | | | |
| Lactic acid | 4 | 4 | 4 | 0 |
| Lecithin | 1 | 1 | 1 | 0 |
| Glycerine | 8 | 8 | 8 | 0 |
| Egg powder | 4 | 4 | 4 | 0 |
| Sorghum flour | 52 | 48 | 0 | 0 |
| Rice Flour | 0 | 0 | 52 | 0 |
| Cinnamon | 0.05 | 0.05 | 0.05 | 0 |
| MEGABEE | 0 | 0 | 0 | 160 |
| supplement | | | | |
| Average | 3.5 +/− | 31.2 +/− | 37.0 +/− | 22.0 +/− |
| Consumption | 2.6 | 3.0 | 5.4 | 7.3 |
| after 6 days | | | | |

There was a large difference in average consumption of PROPLEX DY compared to the Brewers yeast and MEGABEE supplement, even with lactic acid being added.

Study 7. The following formulations were used to feed hives and the average consumption was measured for 4 hives. The formulations and average consumption are presented in Table 16.

TABLE 16
All values are in grams. The amount of water varied
and was added to get a paste consistency.

| | Formulation | Formulation | Formulation | Formulation |
|---|---|---|---|---|
| Ingredient | 1 | 2 | 3 | 4 |
| High fructose | 200 | 200 | 200 | 200 |
| corn syrup | | | | |
| PROPLEX DY | 110 | 120 | 120 | 0 |
| CLARISOY | 48 | 41 | 36 | 0 |
| soy protein | | | | |
| isolate | | | | |
| Sorghum flour | 35 | 29 | 24 | 240 |
| Lecithin | 4 | 4 | 4 | 0 |
| Egg powder | 4 | 4 | 4 | 0 |
| CITRSTIM | 0 | 0 | 10 | 0 |
| mannanoligo- | | | | |
| saccharide | | | | |
| Methionine | 0 | 1 | 1 | 0 |
| KCl | 0 | 0.5 | 0.5 | 0 |
| Cinnamon | 0.1 | 0.1 | 0.1 | 0 |
| MEGABEE | 0 | 0 | 0 | 200 |
| supplement | | | | |
| Average | 17.8 +/− | 22.7 +/− | 27.2 +/− | 32.3 +/− |
| Consumption | 5.9 | 4.6 | 2.6 | 5.4 |
| after 6 days | | | | |

Fresh tofu (about 20 grams) was also offered to each hive, and more than 90% of the tofu was consumed in 72 hours. The bees appear to prefer fermented products, which appears valid since a primary food for rearing new bees is fermented pollens in the form of bee bread in a hive.

Study 8. The following formulations were used to feed hives and the average consumption was measured for 4 hives. The formulations and average consumption are presented in Table 17.

TABLE 17
All values are in grams. The amount of water varied
and was added to get a paste consistency.

| | Formulation | Formulation | Formulation | Formulation | Formulation |
|---|---|---|---|---|---|
| Ingredient | 1 | 2 | 3 | 4 | 5 |
| High fructose | 200 | 200 | 200 | 200 | 200 |
| corn syrup | | | | | |
| PROPLEX DY | 83 | 87 | 98 | 0 | 200 |
| CLARISOY | 44 | 43 | 37 | 0 | 0 |
| soy protein | | | | | |
| isolate | | | | | |
| Sorghum flour | 35 | 29 | 24 | 0 | 0 |
| Wheat flour | 32 | 0 | 0 | 0 | 0 |
| Glycerine | 10 | 10 | 10 | 0 | 0 |
| Lactic acid | 10 | 10 | 10 | 0 | 0 |
| Choline Cl | 2 | 2 | 2 | 0 | 0 |
| Lysine HCl | 2 | 2 | 2 | 0 | 0 |
| Rice Flour | 0 | 0 | 24 | 0 | 0 |
| Lecithin | 6 | 6 | 6 | 0 | 0 |
| Egg powder | 6 | 6 | 6 | 0 | 0 |
| CITRISTIM | 5 | 5 | 50 | 0 | 0 |
| MOS | | | | | |
| Methionine | 0.5 | 0.5 | 0.5 | 0 | 0 |
| KCl | 1 | 0.5 | 0.5 | 0 | 0 |
| Cinnamon | 0.05 | 0.1 | 0.1 | 0 | 0 |
| MEGABEE | 0 | 0 | 0 | 200 | 0 |
| supplement | | | | | |
| Average | 7.9 +/− | 10.4 +/− | 10.9 +/− | 24.6 +/− | 46.1 +/− |
| Consumption | 4.7 | 4.3 | 4.8 | 4.0 | 13.8 |
| after 6 days | | | | | |

The bees numerically preferred the PROPLEX DY yeast product over MEGABEE supplement, even with lactic acid present.

Study 9. The following formulations were used to feed hives and the average consumption was measured for 4 hives. The formulations and average consumption are presented in Table 18.

TABLE 18
All values are in grams. The amount of water varied
and was added to get a paste consistency.

| | Formulation | Formulation | Formulation | Formulation |
|---|---|---|---|---|
| Ingredient | 1 | 2 | 3 | 4 |
| High fructose | 220 | 220 | 220 | 220 |
| corn syrup | | | | |
| PROPLEX DY | 87 | 83 | 98 | 0 |
| PROFAM soy | 43 | 44 | 37 | 0 |
| protein isolate | | | | |
| Sorghum flour | 29 | 0 | 0 | 0 |
| Wheat flour | 0 | 32 | 0 | 0 |
| Rice flour | 0 | 0 | 24 | 0 |
| Lecithin | 6 | 6 | 6 | 0 |
| Egg powder | 6 | 6 | 6 | 0 |
| CITRISTIM | 5 | 5 | 5 | 0 |
| mannanoligo- | | | | |
| saccharide | | | | |
| (MOS) | | | | |
| Methionine | 0.5 | 0.5 | 0.5 | 0 |
| KCl | 1 | 1 | 1 | 0 |
| Lysine HCl | 0.55 | 0.55 | 0.55 | 0 |
| MEGABEE | 0 | 0 | 0 | 180 |
| supplement | | | | |
| Average | 23.4 +/− | 25.8 +/− | 25.6 +/− | 25.3 +/− |
| Consumption | 0.9 | 0.5 | 0.8 | 0.4 |
| after 6 days | | | | |

In this study, the formulations of the present invention were consumed equivalently to the commercially available MEGABEE formulations.

Study 10. The following formulations were used to feed hives and the average consumption was measured for 4 hives. The formulations and average consumption are presented in Table 19.

TABLE 19
All values are in grams. The amount of water varied
and was added to get a paste consistency.

| | Formulation | Formulation | Formulation | Formulation |
|---|---|---|---|---|
| Ingredient | 1 | 2 | 3 | 4 |
| High fructose | 200 | 200 | 200 | 200 |
| corn syrup | | | | |
| PROPLEX DY | 200 | 0 | 0 | 0 |
| Fermacto | 0 | 200 | 0 | 0 |
| Yeaco yeast | 0 | 0 | 200 | 0 |
| MEGABEE | 0 | 0 | 0 | 200 |
| supplement | | | | |
| Average | 37.0 +/− | 0.8 +/− | 6.8 +/− | 9.0 +/− |
| Consumption | 9.6 | 3.8 | 5.5 | 6.1 |
| after 6 days | | | | |

This study provided evidence that bees appeared to prefer lower temperature processed fermented products over higher temperature processed products. There may be some heat damage that occurs to proteins in the various yeast products, other than the PROPLEX DY of the present invention as PROPLEX DY was preferred over the commercially available bee feed.

Study 11. The following formulations were used to feed hives and the average consumption was measured for 4 hives. The formulations and average consumption are presented in Table 20.

TABLE 20
All values are in grams. The amount of water varied
and was added to get a paste consistency.

| | Formulation | Formulation | Formulation | Formulation | Formulation |
|---|---|---|---|---|---|
| Ingredient | 1 | 2 | 3 | 4 | 5 |
| High fructose | 220 | 220 | 220 | 220 | 220 |
| corn syrup | | | | | |
| MEGABEE | 180 | 0 | 0 | 0 | 0 |
| supplement | | | | | |
| Beerwell unders | 0 | 87 | 0 | 0 | 0 |
| GDDY 12-12-668 | 0 | 0 | 87 | 0 | 0 |
| GDDY 12-12-522 | 0 | 0 | 0 | 87 | 0 |
| PROPLEX DY | 0 | 0 | 0 | 0 | 87 |
| PROFAM soy | 0 | 43 | 43 | 43 | 43 |
| protein isolate | | | | | |
| Sorghum flour | 0 | 29 | 29 | 29 | 29 |
| Egg powder | 0 | 6 | 6 | 6 | 6 |
| Lecithin | 0 | 6 | 6 | 6 | 6 |
| CITRISIM MOS | 0 | 5 | 5 | 5 | 5 |
| Choline Cl | 0 | 2 | 2 | 2 | 2 |
| KCl | 0 | 1 | 1 | 1 | 1 |
| Methionine | 0 | 0.5 | 0.5 | 0.5 | 0.5 |
| Lysine HCl | 0 | 0.5 | 0.5 | 0.5 | 0.5 |
| Cinnamon | 0 | 0.1 | 0.1 | 0.1 | 0.1 |
| Average | 9.8 +/− | 13.0 +/− | 25.0 +/− | 27.1 +/− | 25.0 +/− |
| Consumption | 4.8 | 2.2 | 1.7 | 1.4 | 1.7 |
| after 6 days | | | | | |

This study evaluated various yeast products of the present invention in various stages of processing. The “beerwell unders” were consumed at a lower level than the other yeast products of the present invention, but each of the compositions of the present invention were preferred by the bees over the commercially available product.

The present invention discloses a protein supplement in the form of a complex mixture of ingredients and nutrients that targets the currently known nutrient needs for honey bees. In an embodiment, the formula is intended for honey bees for feeding during periods of low natural pollen availability at any time of the year. The formula may be fed as a dry powder or in a pasty mixture with sugar and/or high fructose corn syrup and/or other carbohydrate sources. It is known among nutritionists and those skilled in this art that an optimal balance of amino acids, fatty acids, macro- and micro-minerals, vitamins, and carbohydrates from a variety of sources are needed to provide the optimal levels and balance of these nutrients to support optimal growth and health. In other embodiments, the present invention can also be applied to other insects or insect larvae, such as crickets, raised and used for feeding of animals.

Further, it has been unexpectedly discovered that the use of low temperature drying methods for fermentation biomass products, including the yeast products preferred by honey bees in these studies disclosed herein, appear to be preferred over higher temperature drying of other yeast products commercially available. The PROPLEX DY yeast of the present invention in combination with other ingredients as described herein provides the nutrients required by honey bees as described in the publically available scientific literature.

This disclosure has been described with reference to certain exemplary embodiments, compositions, and uses thereof. However, it will be recognized by those of ordinary skill in the art that various substitutions, modifications, or combinations of any of the exemplary embodiments may be made without departing from the spirit and scope of the disclosure. Thus, the disclosure is not limited by the description of the exemplary embodiments, but rather by the appended claims as originally filed.

1. An insect feed comprising:
a derivative of corn steep liquid;
wherein the derivative of the corn steep liquid is a yeast biomass from an ethanol fermentation grown on a media comprising a corn steep liquid or a derivative thereof.

2. The insect feed of claim 1, wherein the derivative of corn steep liquid is selected from the group consisting of a product derived from fermentation using media comprising a corn steep liquid, solids derived from a corn steeping process, gluten water, corn steep liquor, a microbial biomass, and combinations of any thereof.

3. (canceled)

4. The insect feed of claim 1, wherein the insect feed is a powder.

5. The insect feed of claim 4, wherein particles of the powder have a size of less than 150 microns.

6. The insect feed of claim 1, wherein the insect feed is a liquid or semi-liquid.

7. The insect feed of claim 1, wherein the insect feed is a patty.

8. The insect feed of claim 1, further comprising an ingredient selected from the group consisting of a carbohydrate source, a sugar, a protein source, a cholesterol source, a mannanoligosaccharide source, an anti-oxidant, a preservative, and combinations of any thereof.

9. (canceled)

10. The insect feed of claim 1, wherein at least 40% of protein in the insect feed is derived from the derivative of the corn steep liquid.

11. The insect feed of claim 1, wherein the derivative of the corn steep liquid is substantially free of corn gluten.

12-14. (canceled)

15. The insect feed of claim 1, comprising 70-99% by weight of the derivative of the corn steep liquid.

16. A method of feeding an insect, the method comprising:
feeding the insect feed of claim 1 to an insect.

17. The method according to claim 16, wherein the insect is a bee or a cricket.

18. (canceled)

19. A process for producing an insect feed, comprising:
fermenting a microorganism with media comprising a corn steep liquid, thus producing a biomass containing liquid; and
removing at least a portion of liquid from the biomass containing liquid, thus forming the insect feed.

20. The process of claim 19, further comprising drying the insect feed to a powder.

21-22. (canceled)

23. The process of claim 19, wherein the microorganism is a yeast, biomass from a commercial amino acid biomass, a citric acid presscake, a glutamate biomass, a threonine biomass, a lysine biomass, a microbial biomass, and combinations of any thereof.

24. The process of claim 19, wherein the insect feed comprises 1-60% solids by weight, further comprising:
mixing the insect feed with an ingredient selected from the group consisting of a carbohydrate source, a sugar, a protein source, a cholesterol source, a mannanoligosaccharide source, an anti-oxidant, a preservative, and combinations of any thereof, thus forming a patty or a paste; and
feeding the patty or the paste to an insect.

25. (canceled)

26. The process of claim 22, further comprising:
forming the insect feed into a patty or a paste; and
feeding the patty or the paste to a bee.

27. The process of claim 22, further comprising:
configuring the insect feed into a liquid; and
feeding the liquid to a bee.

28. (canceled)

29. A bee feed comprising:
70-95% by weight of a yeast biomass obtained from fermenting the yeast on a corn steep liquid, wherein the yeast biomass comprises less than 3% by weight of corn gluten;
a carbohydrate source;
a protein source; and
a cholesterol source.

30. The bee feed of claim 29, comprising:
a protein content of 35-65%;
a lipid content of between about 2-10%; a total carbohydrate content of between 10-90%;
a total ash content of between 2-10%; and
a total moisture content of 6-10%.
